(19) United States
(12) Patent Application Publication
(10) Pub. No.: US 2004/0138970 A1
(43) Pub. Date: Jul. 15, 2004

(54) Scripting designer for a billing mediation system

(76) Inventors: Renjith Ramachandran, Cincinnati, OH (US); Chandramouli Swarna, Batavia, OH (US); Niraj Desai, Union, KY (US); Pankaj Patel, West Chester, OH (US)

Correspondence Address: FROST BROWN TODD LLC, 2200 PNC Center, 201 E. Fifth Street, Cincinnati, OH, 45202-4182, US

(21) Appl. No.: 10/724,955

(22) Filed: Dec. 1, 2003

Related U.S. Application Data
(60) Provisional application No. 60/430,274, filed on Dec. 2, 2002.

(51) Int. Cl. G06F 17/60

(52) U.S. Cl. 705/34

(57) ABSTRACT

A mediation system for converged network system for an xSP (i.e., any service provider of Information Technology (IT)/business services) is readily configured to collect revenue related transaction data (usage data) from network elements. A user is able to customize intuitively and efficiently the mediation system for their specific needs by using a Script Design Environment. In particular, a graphical environment presents scripts that receive, parse, validate, format, assemble, correlate and distribute the usage data and provide tools for modifying these scripts.

### CROSS REFERENCE TO RELATED APPLICATIONS

The present application hereby claims the benefit of the U.S. provisional patent application of the same title, Serial No. 60/430,274, filed on 2 Dec. 2002. The present application claims the benefit and hereby incorporates by reference in their entirety the two U.S. nonprovisional patent application Ser. No. 10/190,728, “FLEXIBLE EVENT CORRELATION AGGREGATION TOOL” to Swarna et al. and U.S. patent application Ser. No. 10/190,844, “FLEXIBLE NETWORK ELEMENT INTERFACE” to Swarna et al., both filed on 8 Jul. 2002.

### FIELD OF THE INVENTION

The present invention pertains to a data management system for real-time collecting and distributing data, and more particularly, for correlating and assembling revenue generating transaction data from one or more collection points for distributing to billing-related systems such as a billing system, fraud system, rating system, write-off system, and a clearing house outcollects.

### BACKGROUND OF THE INVENTION

Communication service providers in the recent past have represented three different markets: wireless, fixed line (Internet Protocol (IP)/wireline) and cable/broadband. Each service was separately provided through dedicated hardware and software and separately priced. Usage for billing purposes was a straightforward matter of monitoring time of usage, for instance.

Access providers are those service providers that provide IP connectivity between the end subscriber and the Internet, which can be characterized as providing a “communication” role in this value chain. These access providers are already experiencing a shift away from dial-up access to “always-on” broadband connections to homes and businesses. Content providers provide the video, text, voice and data that are communicated by the access providers. These content providers are experiencing a shift from a small number of communication formats to a large variety of formats.

Technological advances and customer demand for integrated access to a variety of voice, video and data services is increasingly causing a convergence in these markets. In particular, varied services such as basic e-mail, internet access, voice-over-IP (voIP), video mail are being provided as bundled service for use over a wide variety integrated devices, such as PCs, wireless phones, personal digital assistants (PDA), and Internet appliances. As used herein, xSPs, are defined as providers of IP-based services: wireless, cable/broadband, Internet Service Providers (ISPs), Application Service Providers (ASPs), wireline and next-generation service providers.

xSPs are beginning to launch multiple services by aggregating content through partnerships with content owners. Being first to market with bundled service packages, these xSPs will be presented with great opportunities and great challenges to woo and win customers by offering new margin-rich services. But in order to retain the customer, win market share, and derive profits for the long term, these xSPs must have customer care and billing services that work in this complex new environment. Thus, once a customer is provisioned, mediation—capturing and measuring usage from different network elements—is the next hurdle in the multi-market, multi-service, multi-business model. Traditionally, all mediation by an xSP tended to be self-contained within that xSP's operation.

As networks increase in complexity and the value of real-time information expands, the ability to quickly and to easily manage network changes and multiple formats is growing as well. Acting as the isolation layer, mediation systems such as Real-Time Processing Manager (RPM) (a.k.a., Mediation Manager) advantageously provides the reliable data handling necessary to interface between ever-changing network elements and applications. The RPM enables operators to quickly introduce new services and change existing services. The module simultaneously supports existing network infrastructures as well as evolving infrastructures, enabling billing for events generated using network technologies such as TDMA (Time Division/Demand Multiple Access), CDMA (Code Division Multiple Access), GSM (Global System for Mobile Communication), GPRS (General Packet Radio Service), UMTS (Universal Mobile Telecommunications System), and CDMA2000.

Acting as the communications gateway for the collection of events, the RPM ultimately results in increased revenue for the service provider via accurate and reliable delivery of network usage data. RPM supports high-capacity data collection from multiple networks. It acts as collector, aggregator, reformatter, and distributor, enabling standardized processing of usage information generated in multi-vendor, multi-service networks. The Web-based user interface places more power into the hands of the user, lowering total cost of ownership by enabling the operator to configure and maintain the application regardless of the chosen delivery option. Configurable business rule definition, filtering, duplicate and gap checking, error processing, and other user definable parameters offer maximum flexibility in usage processing. This fully functional, modular application supports multiple market segments and technologies simultaneously, enabling the service provider to have a single, convergent mediation platform upon which to support its business needs. The RPM supports both prepaid and postpaid networks in a single mediation environment, enabling the carrier to provide diverse services to its customers without sacrificing revenue assurance, flexibility, and control. Also, since the RPM serves as a transparent isolation layer between applications and service/network elements, the impact to the systems with which it interfaces is minimal.

Supporting both circuit-switched as well as IP networks, the RPM application provides a simplified and standardized interface for the acquisition of billing data. Its capabilities include: (a) convergent pre-paid and post-paid mediation support; (b) event validation, editing, gap and duplicate checking; (c) error correction (individual and mass); (d) carrier control of event collection processes via Graphical User Interface (GUI)/table-driven parameters; (e) event aggregation, reformatting, event correlation, and call assembly; (f) enterprise-specific field validation, business validation, data manipulation rules; (g) filtering and grouping; (h) reformat definition/application; (i) revenue assurance: audits and controls with extensive reporting and analysis; (j) mediation data record search capability; (k) role-based security; (l) multi-standard roamer processing.

ASCII Positional Variable (APV) Scripting Language (ASL) is a powerful aspect of RPM. ASL identifies mediation data usage requiring validation and manipulation; creates the rules for such validation and manipulation; identifies and formats data for downstream system needs; identifies data for searching purposes; and filter data from or include data to downstream systems.

Recently, a Mediation Manager has demonstrated a more adaptable RPM application, as described in the commonly-owned and co-pending application Ser. No. 10/190,728 entitled “FLEXIBLE EVENT AGGREGATION CORRELATION TOOL” and Ser. No. 10/190,844 entitled “FLEXIBLE NETWORK EVENT INTERFACE”, both to Swarna, et al., and filed on 8 Jul. 2002, and both of which having been previously incorporated by reference in their entirety. As described therein, the Mediation Manager was more readily configured for receiving data from new network elements and for correlating and aggregating the data by improvements such as added New Element ASL scripts and GUI windows.

Thus, RPM in general and more particularly a Mediation Manager have largely succeeded in allowing xSP providers to dynamically adapt to changing data mediation needs. For instance, the Mediation Manager uses an Applet-based Script Editor that allowed the users to edit and compile the scripts on the User Interface, thereby avoiding the inefficiencies and inconvenience of having the software developer modify the Mediation Manager for their unique needs.

While these improvements have allowed customers to add new Network Elements and perform custom aggregation and correlation of the received data, opportunities exist for further improvements.

Consequently, a significant need exists for a network element data handler for a mediation system for a converged network system for that may be readily and intuitively configured by the xSP customer.

### BRIEF SUMMARY OF THE INVENTION

The invention overcomes the above-noted and other deficiencies of the prior art by providing a scripting manager for a mediation manager of an xSP billing system provides an intuitive GUI to users to rapidly adapt to unique needs.

These and other objects and advantages of the present invention shall be made apparent from the accompanying drawings and the description thereof.

### BRIEF DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a diagram of a converged network system for providing xSP services wherein a mediation manager consistent with the present invention provides an interface for revenue generating transaction data.

FIG. 2 is a diagram of Flexible Network Element (Flex NE) Interface of the Mediation Manager of FIG. 1.

FIG. 3 is a diagram of an ASL Designer of the FlexNE interface of FIG. 2.

FIG. 4 is a depiction of a presentation layer for the ASL Designer IDE tool of FIG. 3.

FIG. 5 is a depiction of a workbench Graphical User Interface (GUI) window of a desktop ASL development environment.

FIG. 6A is a GUI window that displays the ASL script in a graphical depiction.

FIG. 6B is a GUI window that displays the ASL script as text.

FIG. 7 is a navigator bar, a child window of the window of FIG. 6, which displays the available ASL scripts in the domain and helps the user edit an existing ASL or create a new ASL.

FIG. 8 is a tool for displaying NE and APV definitions.

FIG. 9 is a child window of the window of FIG. 6, which displays the structure of the script displayed in the active ASL editor.

FIG. 10 is a depiction of a keyword palette, which is a child view of the window of FIG. 6, which lists all the keywords relevant to the ASL script being edited.

FIG. 11 is a depiction of a reference palette, which is a child view of the window of FIG. 6.

FIG. 12 is a login dialog window that may be invoked from the workbench menu or toolbar.

FIG. 13 is a block diagram of a graphical design model representation of default rule structure.

FIG. 14 is a block diagram of a function body definition for configuring the default rule structure of FIG. 13 in a case scenario.

FIG. 15 is a block diagram of a method associated with a function shown in FIG. 14 that contains mapping logic.

FIG. 16 is a block diagram of graphically depicting field mapping.

FIG. 17 is a depiction of a GUI window displaying a tree hierarchical depiction of subrecords, fields and rules.

FIGS. 18-20 are mediation flow representations for normalization of usage data, processing of MDUs, and routing of MDUs to distribution points.

FIG. 21A is a depiction of a version control repository configuration window.

FIG. 21B is a depiction of a version control repository window.

### DETAILED DESCRIPTION OF THE INVENTION

Mediation Manager

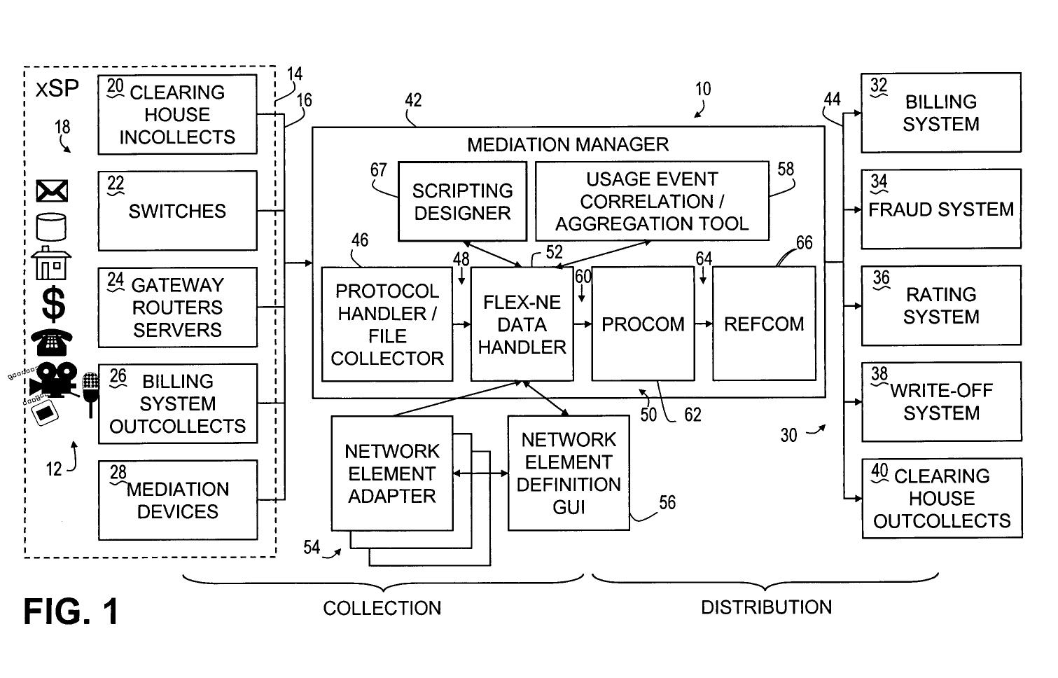

With reference to the Drawings, wherein like numbers refer to like components through the several views, FIG. 1 depicts a converged network system 10 for providing xSP (i.e., any service provider of Information Technology (IT)/business services) content 12 to customers via an xSP operator network 14. Examples of xSP content 12 include e-mail, Internet access, voice-over-IP (voIP), video mail, Simple Mail Transfer Protocol (SMTP) or Multipurpose Internet Mail Extensions (MIME) wireless, H.323 Serial Interface Protocol (SIP) data, MPEG (Moving Picture Experts Group Audio/Video, HTTP (Hyper Text Transfer Protocol) data, etc. Delivery of the xSP content 12 gives rise to revenue generating transaction data (usage data) 16 that is collected by a plurality of network elements (NEs) 18, such as clearing house incollects 20, switches 22, gateway routers/servers 24, billing system outcollects 26 and mediation devices 28.

Each of these types of NEs 18 tends to reflect different types of xSP content 12 and to be developed by different vendors. Consequently, the usage data 16 is generally raw data in different formats with varying types of information content. The usage data 16 is raw in that it tends to include errors, such as duplicate records and invalid data. The nature of the usage data 16 makes difficult its use by xSP billing-related systems 30, such as a billing system 32, a fraud system 34, a rating system 36, a write-off system 38, and a clearing house outcollect 40. Consequently, a Mediation Manager 42 consistent with the present invention collects the usage data 16 from the NEs 18 and distributes validated, reformatted data 44 to the xSP billing-related systems 30.

The Mediation Manager 42 accomplishes this collection of the message-based and/or file-based usage data 16 with a protocol handler/file collector 46, which receives the usage data 16 from the physical device/external device of the respective NE 18, checking for some common functionality. Thus, received data 48 is thereafter given to a Flexible Network Element Interface (“Flex NE”) 50 that processes the received data 48 into a standardized format, which in the illustrative embodiment is termed ASCII Positional Variable (APV), for further manipulation and processing. The Flex NE data interface 50 includes a Flex NE data handler 52 that is configured by one or more network element adapters 54 for the various data formats of received data 48, corresponding to different types of NEs 18. These adapters 54 may be bundled with the Mediation Manager 42, transmitted to the client for plugging into a fielded Mediation Manager 42, or created via a Network Element Definition Graphical User Interface (GUI) 56.

The Flexible NE Interface 50 includes a usage event correlation/aggregation tool 58 that advantageously interacts with the Flex NE data handler 52 to perform call assembly. Call assembly includes matching records from a plurality of collection points. As an illustrative but not all inclusive list, the Flexible Network Interface 50 of the Mediation Manager 42 supports at least the following types of call assemblies: (1) Voice Touch (Assembling Administrative Records with multiple Connected Call Records); (2) Directory Assisted Call Completion (i.e., assembling Administrative Records with multiple Connected Call Records); (3) Lucent Data Services (i.e., assembling Packet Data Protocol (PDP) Records with Master Data Packet (MDP) records); (4) GPRS (i.e., assembling Server GPRS Serving/Support Node (SGSN) and Gateway GPRS Serving/Support Node (GGSN) records); (5) VoIP (i.e., assembling Start and Stop records); and (6) Ericsson Toll Ticket Assembly. One purpose of the Flexible NE Interface 50 is to provide a single and flexible call assembly capability that resolves all different call assembly scenarios, is user configurable, and supports call assembly across one or multiple Network Elements 18.

With collection completed by the Flex NE data handler 52, the Mediation Manager 42 transfers collected data 60 to a process manipulator (“Procom”) 62 for field and business validation and data manipulation. Procom 62 performs functions such as locating duplicates or gaps in the collected usage data, range errors in specific fields, and substitutions of data based on specified criteria. Validated data 64 from Procom 62 is then processed by a distribution reformatter (“Refcom”) 66, which reformats and directs portions of the validated data 64 as appropriate to its destination in the xSP billing-related systems 30.

ASCII Positional Variable (APV) Scripting Language (ASL) Editor (Scripting Designer) 67 enhances the flexibility of both collecting and distributing data of the Mediation Manager 42 by providing abilities for the end user to configure the system to adapt to changing architectures and needs. In addition, to ability to work with network element adapters and to select aggregation and correlation, this Scripting Designer 67 creates a Scripting Design Environment that enables great customization of the Mediation Manager 42 in general, as described below.

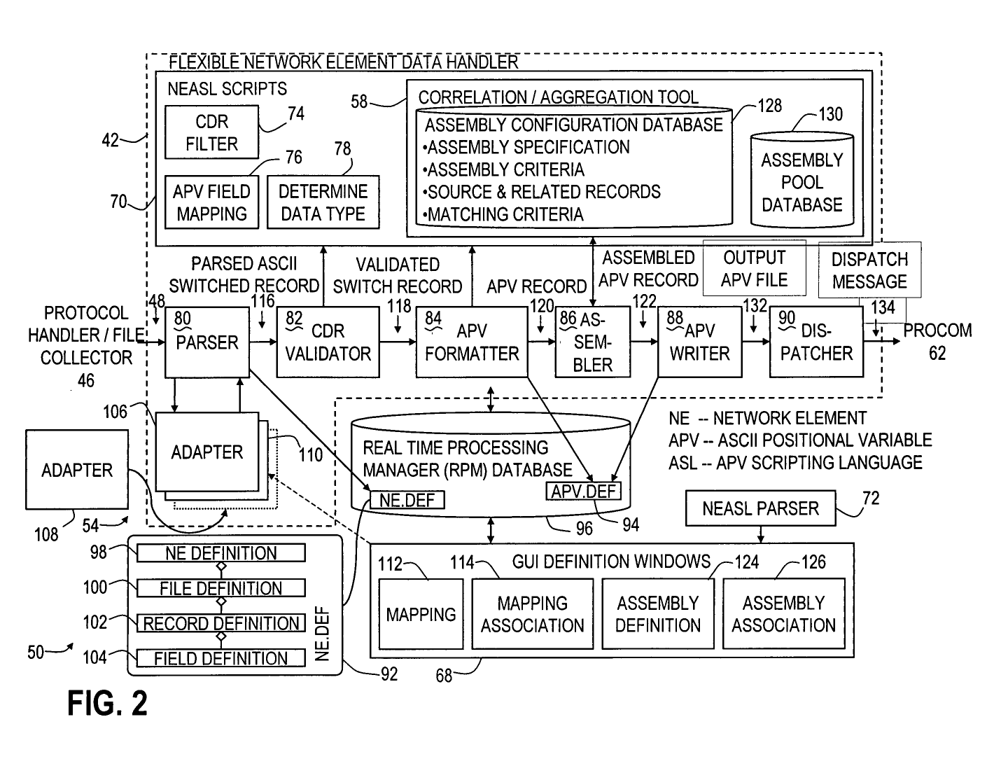

FIG. 2 depicts in greater detail the Flex NE Interface 42 for advantageously completing collection processing of the received data 48 by formatting any type of usage data 16 into APV format using an adaptive and interactive approach. In particular, a Graphical User Interface (GUI), presented as GUI definition windows 68, are interpreted by the Mediation Manager 42 via a precompiled network element APV Scripting Language (NE ASL) scripts 70, parsed by an NE ASL parser 72. Examples of precompiled NE ASL scripts 70 include a CDR filter script 74 (event bypassing) for determining format errors, an APV field mapping script 76 (event mapping) for converting CDR to APV, and a determine data type script 78 for detecting types such as attribute value (AV), ASCII, XML, ASN.1, VCD/BCH/BIN, etc.

Collection Processing Flow

The NEASL Scripts 70 are used to convert usage data 16 into collected data 60. In particular, the conversion processing flow of the Flex NE interface 50 is performed in turn by a Parser 80, a Call Detail Record (CDR) validator 82, an APV formatter 84, an assembler 86, an APV writer 88, and a dispatcher 90. Each stage 80-90 of the Flex NE interface 50 is configured by using the NE ASL scripts 70 and by accessing interactively configured definitions for the format of the received data 48, depicted as “ne.def” metadata 92, and an APV definition for an assembled APV record, depicted as “apv.def” metadata 94. The definition files ne.def metadata 92 and apv.def metadata 94 are both stored in a real-time processing manager (RPM) database 96.

The ne.def metadata 92 includes an NE definitions superclass 98 having an aggregation association with file definition 100, which further has an aggregation association with record definition 102, which in turn has an aggregation association with field definition 104. The parser 80 parses and stores the received data 48 into the format that is specified for the given NE 18 in the ne.def metadata 92. In addition, the parser 80 converts the raw received data 48 into an ASCII format that may be viewed via the GUI definition windows 56. The parser 80 also identifies received data 48 that cannot be decoded/parsed for processing by an error manager.

The parser 80 is configured by the plurality of adapters 54, which may include a bundled adapter 106 that was included with the Flex NE interface 50, a downloaded adapter 108 which is received after installation of the Flex NE interface 50, and an interactively defined adapter 110 produced via the GUI definition window 68, depicted as mapping windows 112 and mapping association windows 114. The parser 80 produces thereby a parsed ASCII switched record 116 to the CDR validator 82. Additional description of the parser 80 and adapters 54 are provided in a co-pending and commonly-owned application entitled “Flexible Network Element Interface” to Swarna, et al., filed on even date herewith and incorporated by reference in its entirety.

For a given NE 18, a user specifies the required validation rules for all CDR types via GUI using NE ASL scripts 70. The CDR validator 82 checks the CDR against those specified validation rules, created with the CDR filter scripts 74. If validation succeeds, then the CDR becomes a validated switch record 118 that will be further processed. If validation fails, those CDRs will be processed by the error manager.

Once a call detail record (CDR) is decoded and validated, APV formatter 84 converts the validated switch record 118 into an APV record 120 in accordance with the associated CDR to APV mapping rules defined in the apv.def metadata 94, created with the APV field mapping scripts 76. With the usage data 16 now in the standardized format of the APV record 120, collection is complete and distribution processing begins.

The assembler 86 correlates and aggregates the APV records 120 into assembled APV records 122. The assembly definition and association windows 124, 126 define first record identification, other record(s) identification, matching criteria, assembly criteria, assembly topology that are stored in an assembly configuration database 128 as an assembly specification, assembly criteria, source and related records definition, and matching criteria. The unassembled APV records 120 are temporarily stored and manipulated in an assembly pool database 130, which like the assembly configuration database 128, is part of the correlation/aggregation tool 58. Management of the assembly pool database further includes reporting on unmatched APV records 120, reconciliation of assembled APV records 122, and purging of the assembly pool database 130.

In the illustrative embodiment, the correlation/aggregation tool 58 supports various types of call assemblies to include Voice Touch (Assembling Admin Records with multiple Connected Call Records); Directory Assisted Call Completion (Assembling Admin Records with multiple Connected Call Records); Lucent Data Services (Assembling PDP Records with MDP records); GPRS (Assembling SGSN and GGSN records); VoIP (Assembling Start and Stop records); and Ericsson Toll Ticket Assembly. The correlation/aggregation tool provides a generic call assembly capability for the above-mentioned types of assembly as well as others. The components of the Flexible NE Assembler include the GUI, which is responsible for specifying assembly rules; include the which is responsible how to interpret and store the Scripting language commands; and include the Assembler, which is the module responsible for doing actual call assembly in accordance to the configuration rules.

Assembling any two records consist of the following steps. (1) Identification of Records: An assembly related record may be identified either by one field or group of fields in the record. (2) Matching Criteria: Two related records can be assembled through some criteria. The criteria may be as simple as check for one field or check for multiple fields with multiple expressions. (3) Assembly Process: This involves populating information from one record into another record or creating a new record by populating the information from all the input records.

The Assembly Topology may be (1) one record assembled with exactly one record to produce one assembled record, (2) one record assembled with many other records within a network element to produce one assembled record, and (3) one record assembled with many other records within a network element to produce many assembled records. Moreover, each of the above assembly operations may be done within a given Network Element or across multiple Network Elements, but of similar type. It will be appreciated that each may further be done across multiple Network Elements of different types.

In the illustrative embodiment, at the point where the assembly script is made to run: (1) The Source/Main GPRS record is identified; (2) All the Partial Records in the Database are retrieved using the matching criteria; (3) Irrespective of the type of the record (either partial or main), this record is sent one at a time to the script; (4) The scripts are receives in MDU form in the existing RC scripts; and (5) All of the partial and the main records are stored in a certain container and for each record in the container the script is called.

The APV writer 88 takes the assembled APV records 122 and writes them into an output APV file 132 in accordance with the apv.def metadata 88. The APV writer 88 has flow controls such as volume based/time based. That is if the output APV records exceeds a threshold value, then the APV Writer can close a given output APV file 132 and open another output APV file 132 for the same assembled APV record 122. The APV dispatcher 84 receives the output APV file 132 and sends a dispatch message 134 to Procom 62 via a comserver for further distribution processing.

Scripting Design Environment.

Recently, ASL has evolved into the core of the Mediation Manager 42, enabling the overall flexibility throughout all the components and features of a Mediation Manager 42 to ensures easier maintenance of ASL. In particular, previous ASL editing was limited to managing a list of scripts in a web-based GUI (e.g., Applet based ASL Editor for editing individual scripts on the Web User Interface) with limited support for importing and exporting of ASL scripts.

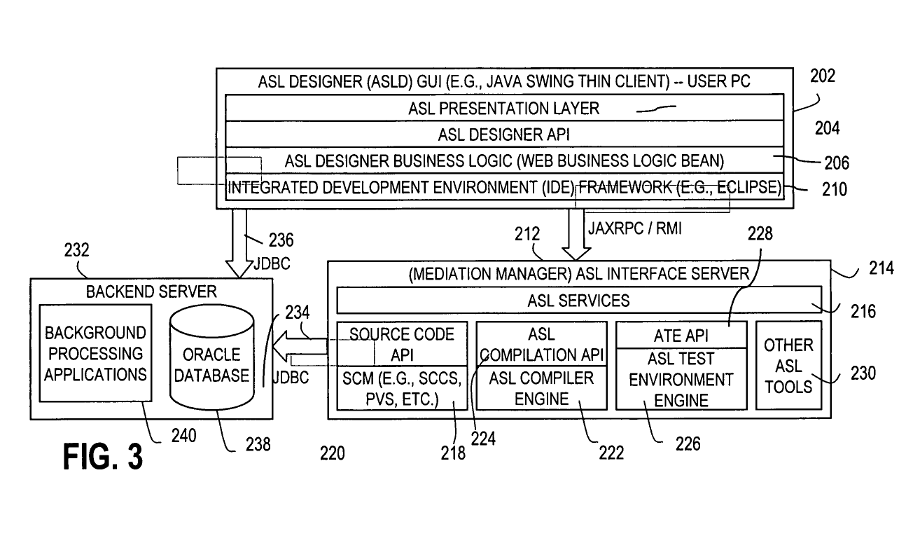

By contrast, an enhanced Scripting Designer 200 consistent with the present invention provides additional capabilities for ASL, enhancing the approach from editing ASL to managing ASL by providing a better and richer user interface for editing ASL scripts, access to configuration management capabilities for source code/version control of ASL scripts, instant testing for ASL, and graphical editing of ASL scripts. These functions and more provided by an ASL Designer (ASLD) GUI 202 depicted in FIG. 3, which in the illustrative version is advantageously based on a JAVA SWING based thin client server architecture that may be run on a different machine than the server, such as being delivered to various user PC by WEBSTART. Swing is the set of GUI related classes supplied with Java Development Kit (JDK)1.2. For instance, JTable, JTree, JList and the subclasses of JTextComponents are easy to update their contents due to their “Model-View-Controller” architecture, which means the centralized data can be shared by client programs over the net. (All other Swing GUI components are also based on the Model-View-Controller architecture. Swing GUI components are “Event-driven”, which enables one to define how each component respond to the actions from the users at our hand. With these characters, we can take the full advantage of Object Oriented Programming (OOP) and build up enterprise oriented GUI easily.

The ASLD GUI 202 provides an ASL presentation layer 204, an ASL Designer Application Program Interface (API) 206, an ASL Designer Business Logic layer (e.g., web business logic bean (BLB)) 208, and an integrated development environment (IDE) framework (e.g., freeware ECLIPSE) 210 the provides an environment for editing/compiling scripts and programs. The ASLD GUI 202 communicates via a Remote Management Interface (RMI) 212 formed as a JAVA API for eXtensible Markup Language (XML)-based Remote Procedure Call (RPC) (JAXRPC) to an ASL Interface Server 214. The ASL Interface Server (ASLIS) 214 is the interface to a domain of the Mediation Manager 42, through which the IDE framework 210 performs the server-related tasks. The ASLIS 214 is a collection of web services that runs in application space of an instance of the Mediation Manager 42. JAX-RPC enables Java technology developers to build Web applications and Web services incorporating XML based RPC functionality according to the SOAP (Simple Object Access Protocol) 1.1 specification. By using JAX-RPC, developers may rapidly achieve Web services interoperability based on widely adopted standards and protocols. ASL services 216 are hosted on the ASL interface server 214, as well as a Source Code Management application (e.g., Source Code Control System (SCCS), Proof Verification System (PVS), etc.) 218 via a Source Code API 220. Thereby, the ASLD GUI 202 allows the user to check in and manage versions of ASL in a source code control system. For instance, an SCCS may be running on the same server as the application server. The ASL interface server 214 further hosts an ASL compiler engine 222 accessed via an ASL compilation API 224, an ASL test environment (ATE) engine 226 accessed via an ATE API 228, and other ASL tools 230.

The ASL interface server 214 and the ASLD GUI 202 perform database operations by each respectively communicating with a backend server 232 by JAVA Data Base Connectivity (JDBC) interfaces 234, 236. JDBC (TM) technology is an API that allows access to virtually any tabular data source from the Java (TM) programming language. It provides cross-DBMS connectivity to a wide range of SQL databases, and now, with the new JDBC API, it also provides access to other tabular data sources, such as spreadsheets or flat files. The JDBC API allows developers to take advantage of the Java platform's “Write Once, Run Anywhere (TM)” capabilities for industrial strength, cross-platform applications that require access to enterprise data. With a JDBC technology-enabled driver, a developer can easily connect all corporate data even in a heterogeneous environment. The backend server 232 hosts an ORACLE database 238 and other background processing applications 240 of the Mediation Manager 42.

Thus, the client, or ASLD GUI 202, has a layered architecture to conceal the ASL designer API 206 logic from the ASL presentation layer 204. ASL Presentation Layer 204 is designed and implemented using the IDE framework 210 (Eclipse), which in turn is built over the ASLD business logic 208 of Java and Swing, thereby making it platform independent. The ASL presentation layer 204 uses the ASL designer API 206 to perform all the server tasks and does not perform any direct communication with the mediation ASL interface server or the database server. ASL designer API 206 is a defined set of APIs, which may be used to perform all the functions related to ASL management. This is designed such as to reuse most of the existing business logic objects and database objects. The ASL designer logic in turn uses the existing ASLD (WEB GUI) business logic 208 objects and exposes a defined set of APIs.

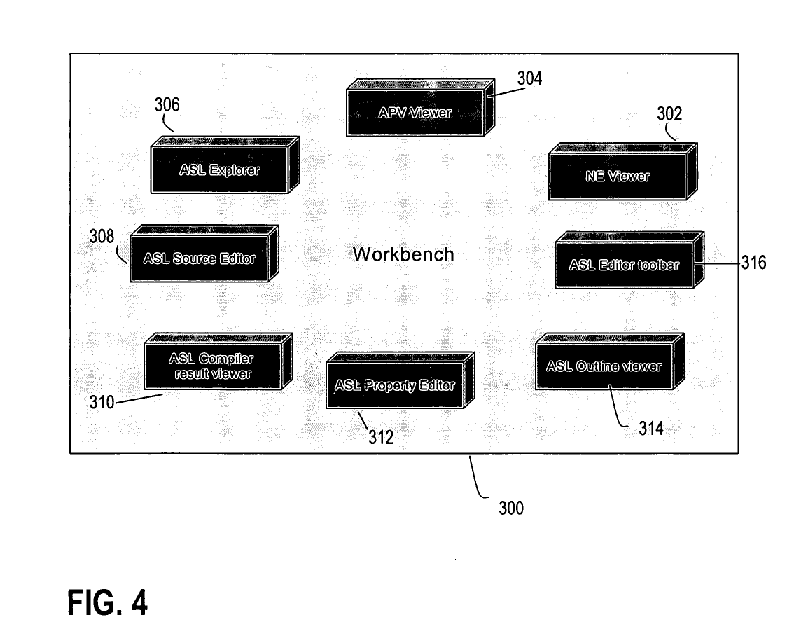

In FIG. 4, an ASL workbench 300 provides a desktop ASL development interface for a user of the mediation manager 42 environment. Each workbench window 300 contains the set of windows, toolbars and menus required to initiate various ASL tasks, providing an ability to export/import ASL scripts into the file system, configurable auto save option, movable and dock able child windows, customizable menus and toolbars, and ability to edit/view multiple ASL scripts simultaneously, etc. In particular, the ASL workbench window 300 includes shortcuts including an NE Viewer icon 302, an APV Viewer icon 304, and ASL Explorer icon 306, an ASL Source Editor icon 308, an ASL Compiler result viewer icon 310, and ASL property editor icon 312, an ASL outline viewer icon 314, and an ASL editor toolbar icon 316.

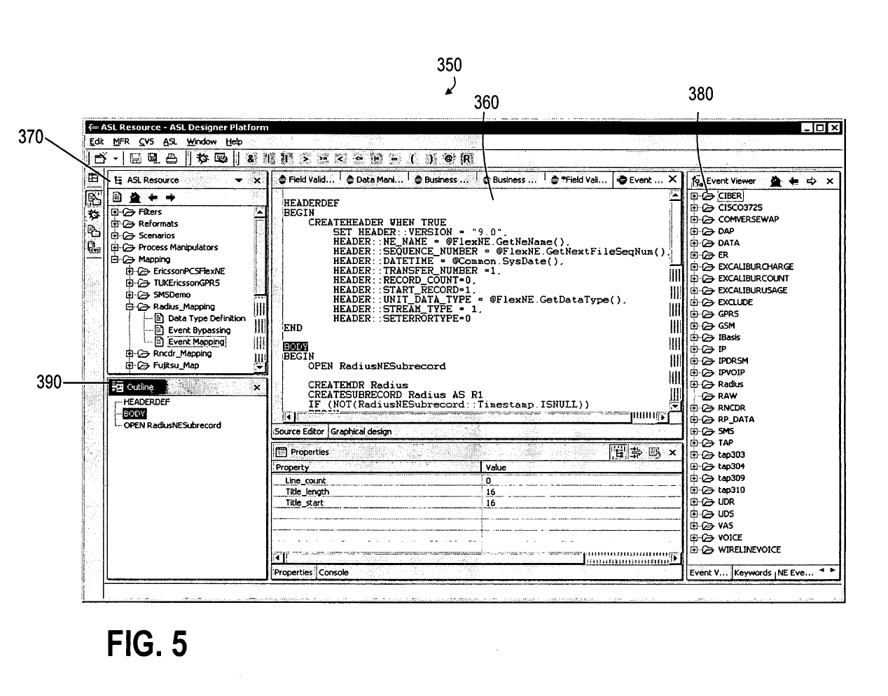

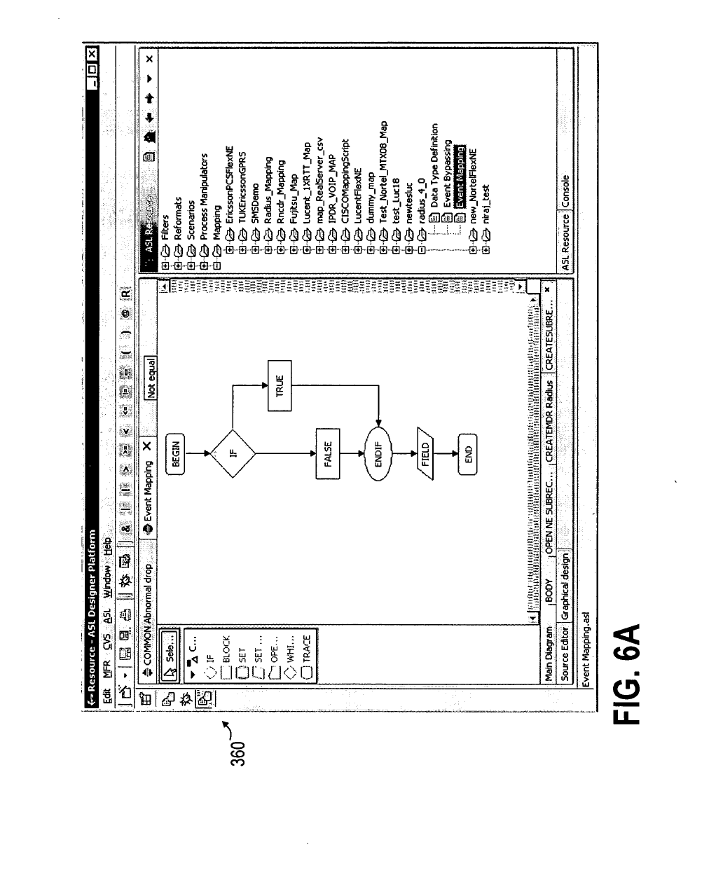

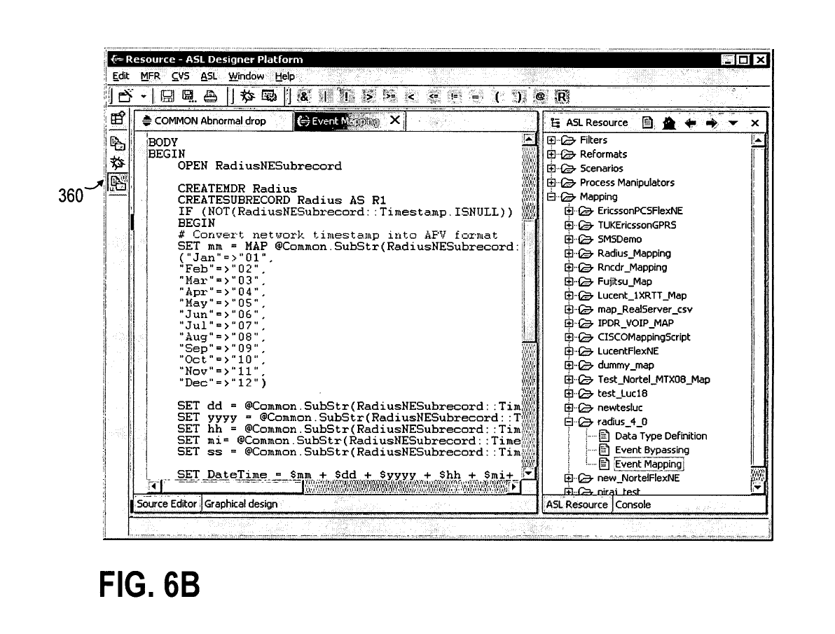

In FIG. 5, a designer window 350 that is launched by the ASL editor toolbar icon 316 provides a range of features. For instance, Fields and Subrecords available as a tree structure are dragged/dropped into the scripting area from the Palette, which is depicted in FIG. 5 and separately in FIG. 6. Control Elements may be dragged/dropped into the scripting area 360. Well-defined templates allow easy start of the ASL creation. The graphical design allows representing ASL Code graphically. Even though it is a difficult issue to represent a programming language graphically, by making some changes to the structure of the script, and making some reorganization this can be achieved to a reasonable level. Representation of the control structure of the script is an example of graphical representation.

Another feature is instant testing of ASL by using a sample APV record that can be pasted into the ASL input window. Instant testing allows an ASL Script created to be immediately tested, hence providing a capability to verify the ASL used.

When large ASL files are being edited it is difficult when the ASL is invalid and the user wants to stop and continue at a later time. The ASL Save capabilities allow the user to save the ASL and continue at a later time.

Stated another way, the enhanced Scripting Designer 200 provides the following advantages and features:

Allow users to view sub-records, fields, operators, and keywords and reference data beans;

Allows users to drag/drop sub-records and fields to the scripting area;

Allows users to drag/drop Keywords, Reference Data bean to the scripting area;

Allows users to add operators;

Allows users to write ASL scripts for Filters, Scenarios, Process Manipulators and

Reformat Definitions;

Allows user to add ASL rule templates depending on the type of ASL being added;

Allows users to save ASL scripts in to files;

Allows user to edit multiple ASL scripts simultaneously;

Provides better editing capabilities while writing a script in the text area;

Provides larger scripting area;

Provides Syntax Editing

Provides Explorer view for various ASL resources;

Allows user to save and load incomplete ASL scripts from local area;

Instant Testing of ASL scripts;

Debugging support;

Version control for ASL scripts;

Support for NE ASL;

Context Sensitive Help;

Smart Templates (ability to add templates depending on the cursor position within

the script, instead of a complete ASL template);

All Configuration capabilities;

WebStart configuration for easier downloads/updates;

ASL Designer Guide; and

Training for End User.

The scripting area, or ASL script, is the window 360 that displays the ASL script in different views, such as source view, graphical view etc. As depicted, the source view is a full-featured text editor with the following features:

Syntax highlighting of the source;

Template based source formatting;

Content type sensitive content assist;

Interactive Content outliner (Two way communication with the content outliner and

dynamic reconciling of the outline page);

Floating toolbar with keywords, operators, rule structure etc.;

Extensive search/replace feature;

Tree model display of APV and NE events with drag and drop support;

Compiler status viewer with source code lookup;

Integrated Debugging features; and

Dynamic problem highlighting.

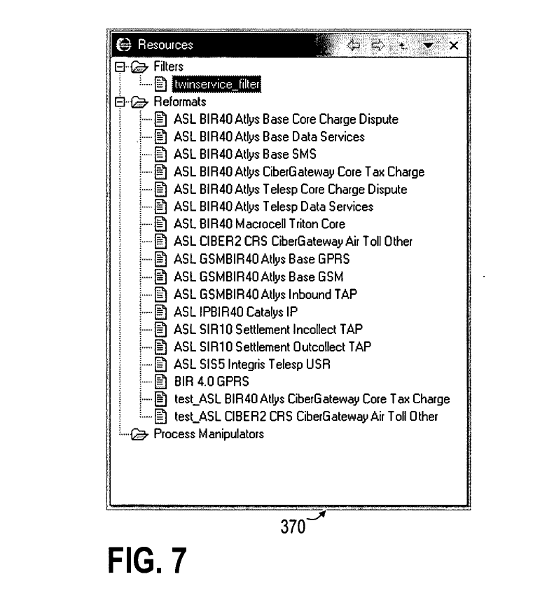

An ASL Explorer window 370 (depicted in FIG. 5 and separately in FIG. 7), which is a child window, is the navigator bar displaying available ASL scripts in the domain and helping the user edit an existing ASL or create a new ASL. It also allows the user to view/edit the attributes of the ASL scripts with a tree model display of various resources;

Double click or menu driven activation of the ASL editor;

Popup menu for ASL property display;

User definable filters for display of resources;

Popup menu for export/import of selected resources;

Popup menu for adding new resources; and

Integrated source repository features.

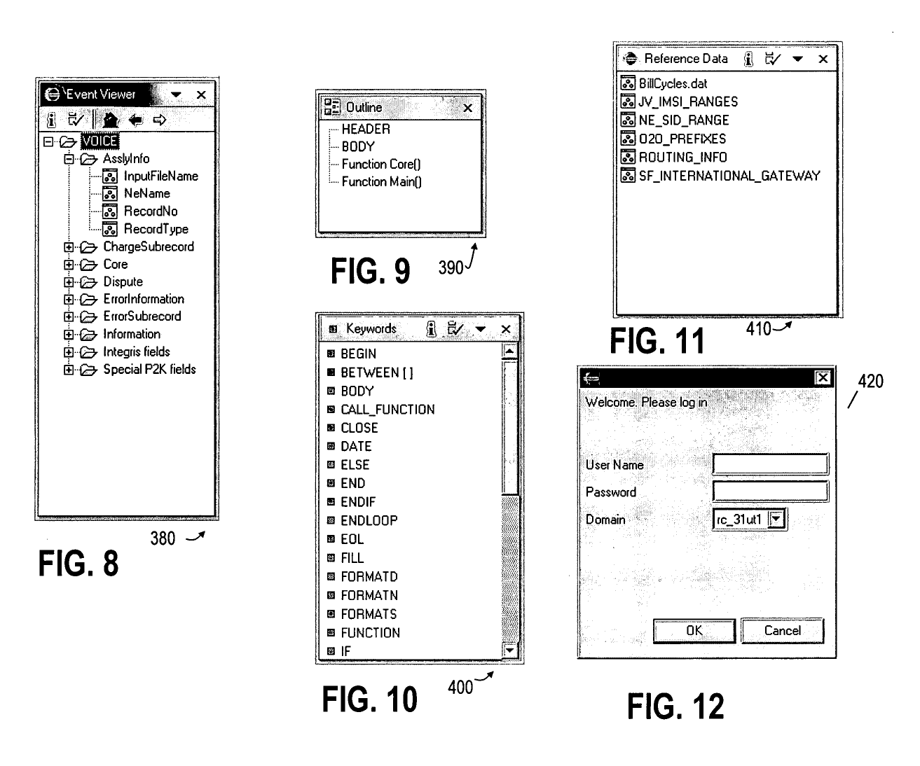

An Event Viewer window 380 (depicted in FIG. 5 and separately in FIG. 8) displays NE and APV definitions, and is invoked as required when the ASL designer window 350 is activated. For normal ASLs, only the APV viewer may be shown and for NEASLs the NE viewer also may be activated: The event viewer window 380 advantageously provides a tree model display of NE and APV events along with drag and drop support to the ASL editor. Double click access to subrecord/field property viewer may be supported as well as displaying the events relevant to the active editor.

A content outline viewer window 390 (depicted in FIG. 5 and separately in FIG. 9), which is a child window, displays the structure of the script displayed in the active ASL editor 360. It is a tree model display of ASL structure, with two-way interaction with the ASL editor, and it changes outline content and appearance based on the active ASL type property viewer/editor. The property viewer is a dialog box, invoked from the popup menus available in the ASL Explorer or from the main menu. It shows the attributes of an ASL script (such as, in a dialog type window to view, update or add ASL scripts, which may be invoked through popup menu from the ASL Explorer window and which corresponds to the attribute screen in the ASL designer window 350.

A keyword palette 400, depicted in FIG. 10, is a child view that lists all the keywords relevant to the ASL script being edited, table model display of keywords, and drag and drop support to the ASL designer window 350.

A reference data palette 410, depicted in FIG. 11 is a child view that lists all the reference data relevant to the ASL script being edited, a table model display of keywords, and drag and drop support to the ASL editor.

A login prompt 420, depicted in FIG. 12 may be invoked from a workbench menu or toolbar. Until the user logs in, the viewers may not display any data. When the login is successfully completed, the ASL explorer window 370 may be refreshed with a list of ASL scripts available in the chosen domain. The list of domains is constructed from domainlist.properties file in the working directory. The listed domains should have <domain>. properties file, which contains necessary information for the designer to connect to the server and perform its operations. Existing RMI interface are used to authenticate user, and the user is allowed to choose a domain.

Graphical design of ASL provides an intuitive efficient approach to editing and creating scripts. For instance, the ASL designer window 350 may display the source view and graphical view in a multi-tab editor, which allows a user to toggle between graphical and source view tabs. In addition to formulating ASL graphical representations; round trip design of ASL enables users to use graphical design and generate ASL source and allows a user to reverse engineer ASL source code and generate a graphical model and to alter the structure of ASL scripts if required. The graphical editing supports graphical modeling and provides toolbars/palettes to assist the creation of various models.

Other features that are included in the ASL designer window 360 may advantageously include a popup menu to reload the resource list (selectively or as a whole) from the database. In addition, a popup menu may provide access to the SCM (e.g., SCCS) with selections such as view, compare, replace, add scripts from local history. Further, user definable filters may be provided to restrict resource display. Configuration control and security may further be enhanced by having user privileges associated with each resource that are considered before accepting defining actions. As yet a further feature, debugging ASL scripts may be facilitated with a debug trace command to the ASL command list. The trace command prints the arguments passed into a trace file, which may be viewed through the ASL designer interface. A debug mode compilation flag may be introduced to avoid the trace statements appearing in the object code of a deployed script.

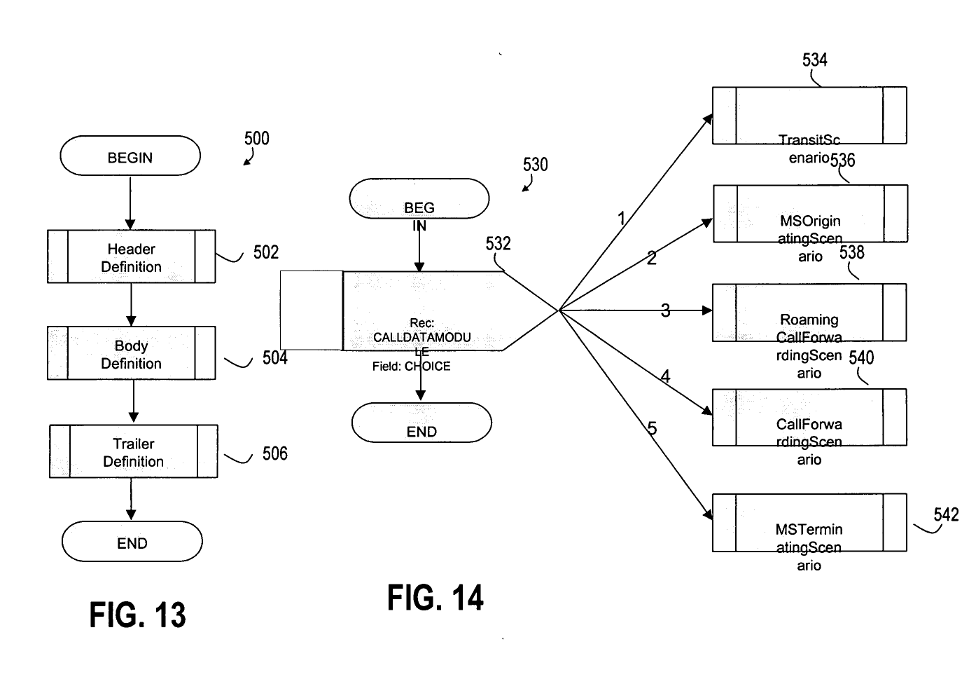

An example of a graphical designer default rule structure as a model 500 is shown in FIG. 13. The user may double click on each method to go into their implementation. The whole script is split into different methods; Header definition 502, Body Definition 504 and Trailer Definition 506 being three predefined methods. Each method is enclosed in a BEGIN and END construct; so is the main method. The header and trailer definitions 502, 506 may have a default implementation.

In FIG. 14, a function body definition 530 is graphically depicted that may invoke other functions. This particular example is a case construct (Rec: call data module; re is: choice) 532 that calls various functions (e.g. Transit Scenario 534, Ms Originating Scenario 536, Roaming Call Forwarding Scenario 538, and Ms Terminating Scenario 538, Call Forwarding Scenario 540, and Ms Terminating Scenario 542), based on respective values 1-5. The Open and Close Statements may be automatically inserted behind the screens.

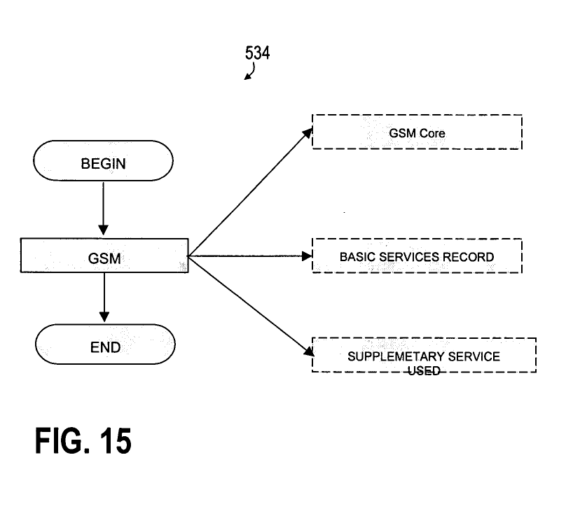

In FIG. 15, the Transit Scenario method 534 is depicted as a graphical design that contains the mapping logic for global system for Mobile Communications (GSM) events. A rectangle denotes CreateMDR block while a dotted rectangle denotes a Createsubrecord block. Double clicking on a create Subrecord block may bring up a palette with field list indicating the mapped fields with Highlighting. Clicking on a field name may open the mapping definition of the field.

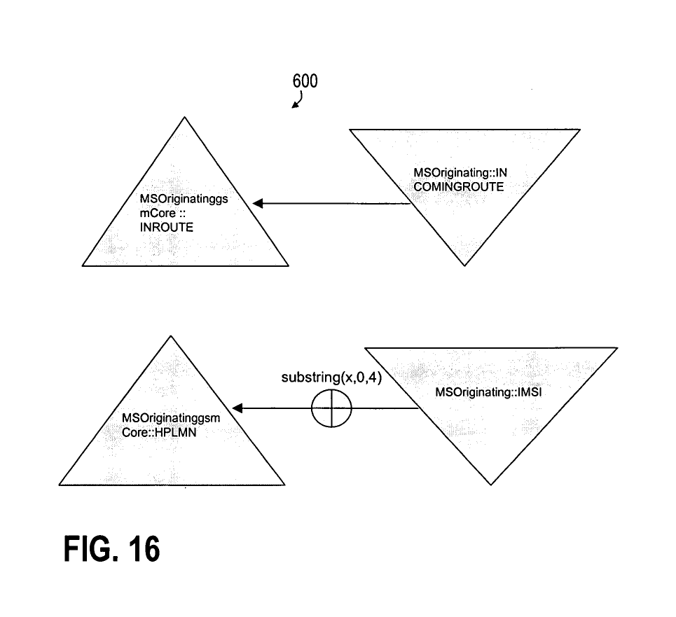

In FIG. 16, a graphical representation identifies different kinds of mapping and formulates methods to represent them. Specifically, a one-to-one mapping diagram 600 wherein a triangle denotes an APV field and an inverted triangle denotes an NE field. A mapping model may be attached to each APV field and is generally not displayed together on a single screen. If the user selects expression-based mapping, then an edit box (not shown) may be provided in the graphical window itself for tying in an expression.

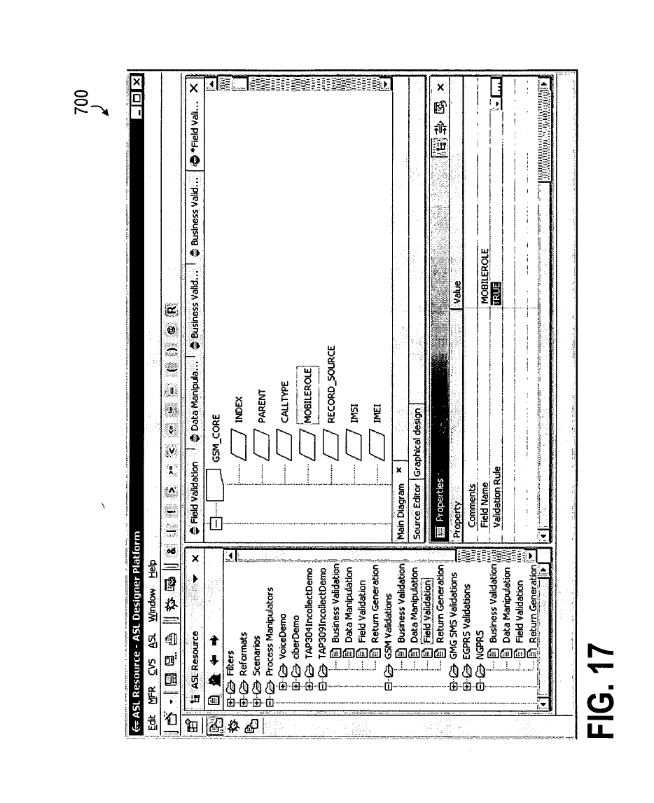

In FIG. 17, a field validation tree structure 700 is depicted with subrecords having fields, which in turn may optionally have validation rules. An indication that a field has rules may be annotated (e.g., green background shading). A user may select an option to hide fields having no validation rules.

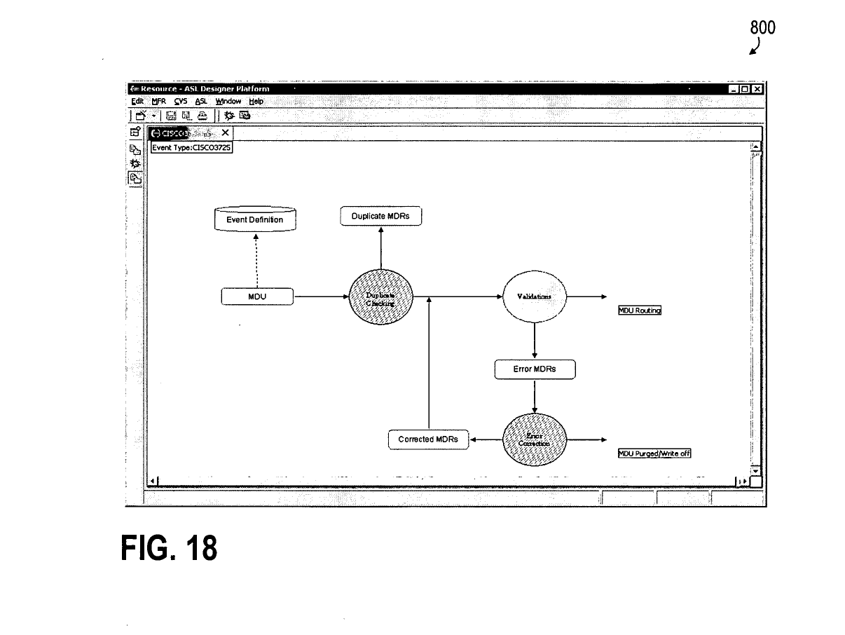

IN FIGS. 18-20, mediation flow representations (MFR) are shown that provide a high-level usage flow depiction to the user from collection to distribution. User may use the MFR diagram to know the status of configurations from end to end. User may also use the MFR diagram to configure the ASL scripts by clicking on the nodal points. The MFR diagram reflects the status of ASL configurations dynamically. As the configurations are filled in, MFRs may automatically be updated to provide graphical feedback.

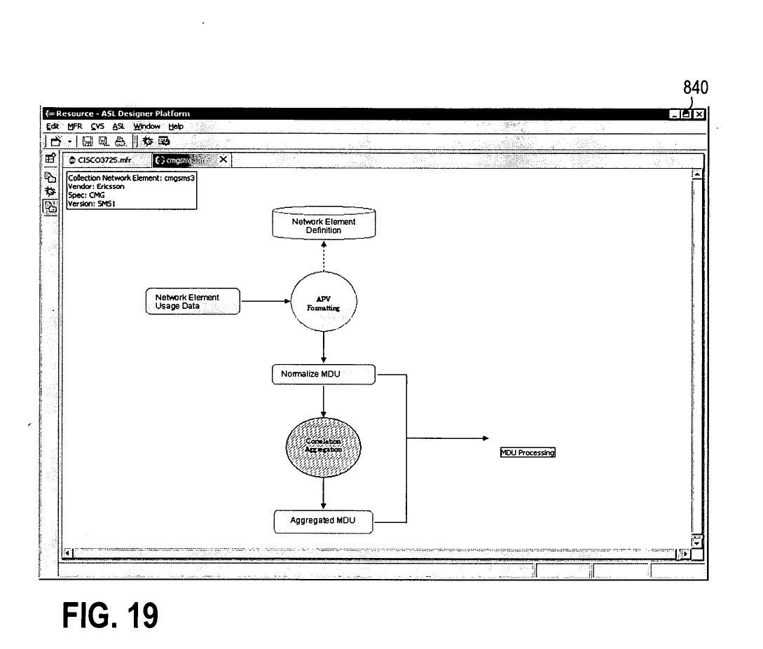

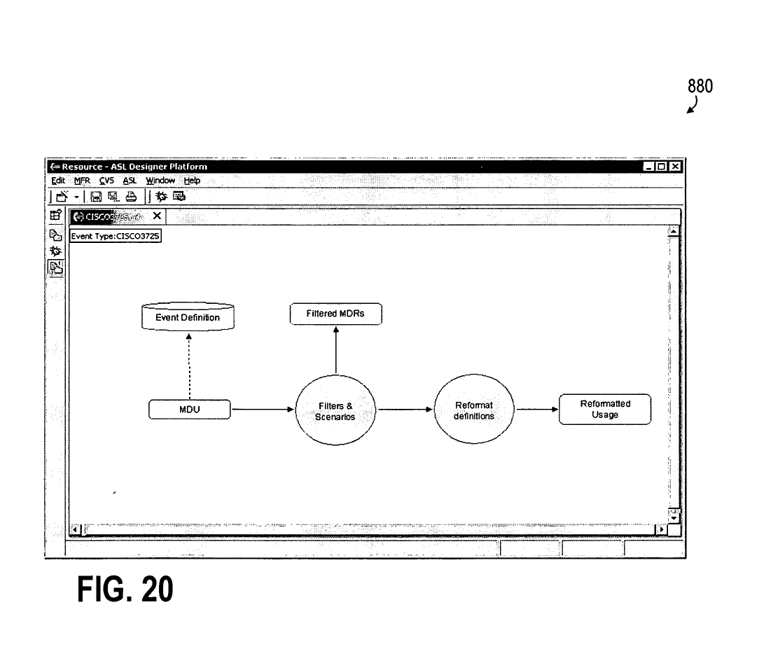

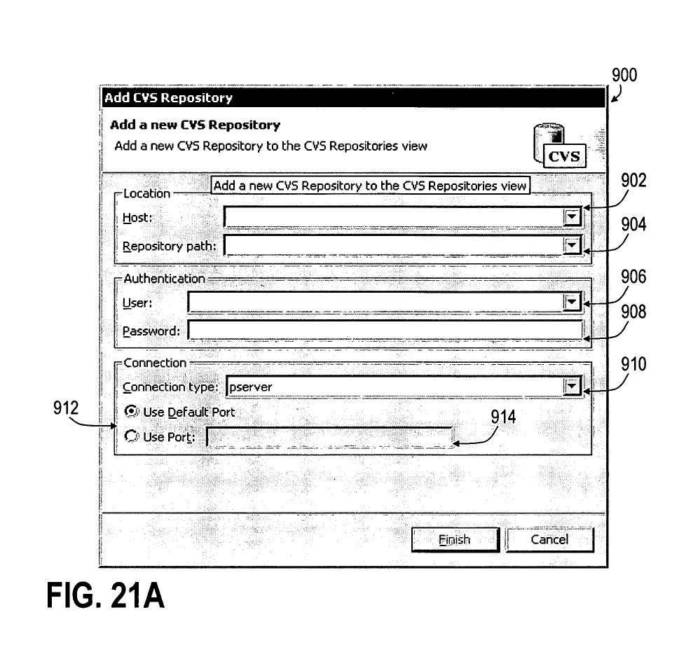

In FIG. 18, an MFR 800 for normalization of usage data is provided in a skeleton view. Shapes, colors, etc. are used to convey information and to make the depiction intuitive. For instance, a circle, such a “APVFormatting” function and “Aggregation” function are circular indicating that these may be edited with the ASL designer whereas a rectangle such a “network Usage”, “normalized MDU” and “normalized MDU or aggregated MDU” are not configurable. A filled circle would indicate configuration is complete whereas an empty circle indicates that configuration has not been done. Links between elements denote processing flow or other types of communication related to the depicted entity. Generally, the MFR diagram and the associated configurations are be-directional with changes being reflected in both the graphical depiction and the stored data base configuration with the user being able to go to the configuration by selecting (e.g., clicking) on the graphical entity. In FIG. 19, another MFR depicts a processing of MDUs function 840. In FIG. 20, an MFR depicts a routing of MDU to distribution points function 880.

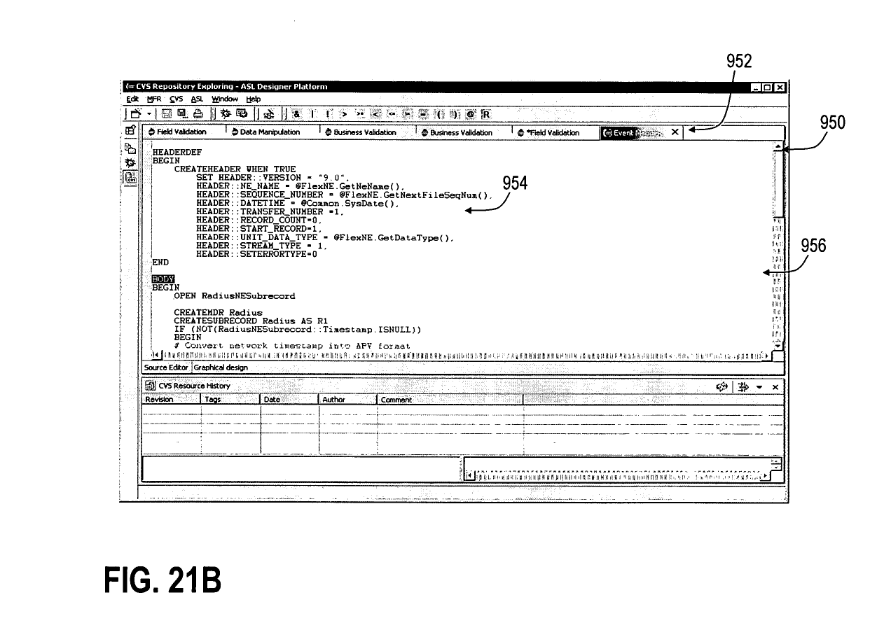

In FIG. 21A, a version control is supported by mapping to a repository of scripts via a version control repository configuration window 900. For instance, the user may select pulldown menus 902, 904, provide authentication via a user pulldown menu 906 and password text box 908, and specify connection type by server pulldown menu 910 and port selection radio buttons and text box 912, 914.

In FIG. 21B, a version control repository explorer window 950 allows selection of a category tab 952 of scripts (e.g., field validation, data manipulation, business validation, field validation, event mapping, etc.) with scripts 954 in that category presented in a script window 956.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

What is claimed is:

1. A mediation manager for a billing system between network elements and revenue-related distribution systems, comprising:
a protocol handler configured to receive usage data from a plurality of network elements and to format the usage data into a standard format;
a data handler configured to parse, format and assemble the standard format usage data in accordance with a plurality of scripts; and
a mediation script designer configured to graphically and interactively present a user with an environment for modifying the plurality of scripts.

2. The mediation manager of claim 1, wherein the mediation script designer is further configured to display a script in a graphical depiction.

3. The mediation manager of claim 2, wherein the mediation script designer is further configured to display a script as a flow diagram.

4. The mediation manager of claim 2, wherein a script contains a modifiable element and a nonmodifiable element, the mediation script designer is further configured to display the modifiable element with a graphical annotation that differs from the nonmodifiable element.

5. The mediation manager of claim 2, wherein the mediation script designer is further configured to selectively display a script in a graphical depiction and as a text depiction.

6. The mediation manager of claim 1, wherein the mediation script designer is further configured to display a script editing window and a resource listing of recorded scripts.

7. The mediation manager of claim 6, wherein the mediation script designer is further configured to respond to a drag and drop operation between a recorded script in the resource listing and the script editing window.

8. A mediation manager for distributing billing-related usage data received from a plurality of collection points of a converged mediation network system, the mediation manager comprising:
a database containing the billing-related usage data;
a mediation manager script interface in electronic communication with the database and operably configured in accordance with a plurality of scripts to perform protocol handling of receive usage data in the database from a plurality of network elements, to format the usage data into a standard format, and to perform data handling to parse, format and assemble the standard format usage data for distribution; and
a script designer responsive to a user and in client communication with the mediation manager script interface and database; the script designer comprising a presentation layer providing a platform independent graphical user interface that is coupled to an integrated testing environment framework for communicating with the mediation manager.

9. The mediation manager of claim 8, wherein the mediation manager is further configured to accesss script verions control repository, the script designer furhter configures to respond to a user to interact with the script verions control repository.

10. A mediation manager for distributing billing-related usage data received from a plurality of collection points of a converged mediation network system, the mediation manager comprising:
a means for receiving and protocol handling the usage data from the plurality of collecton points;
a means for assembling, correlating and sitributing the usage data to a plurality of billing system outcollects; and
a means for remotely presenting a graphical user interface for editing a pluralit of scripts that control the means for receiving, protocol handling, assembling, correlating, and distributing the usage data.
